(19) United States
(12) Patent Application Publication
(10) Pub. No.: US 2013/0082471 A1
(43) Pub. Date: Apr. 4, 2013

(54) ELASTIC STRAP ASSEMBLY

(71) Applicant: RICHARD S. CASTORANO, COLUMBUS, OH (US)

(72) Inventor: RICHARD S. CASTORANO, COLUMBUS, OH (US)

(21) Appl. No.: 13/556,990

(22) Filed: Jul. 24, 2012

Related U.S. Application Data
(60) Provisional application No. 61/540,874, filed on Sep. 29, 2011.

(51) Int. Cl. B65G 7/12

(52) U.S. Cl. 294/25

(57) ABSTRACT

A strap assembly is provided comprising an elongated member adapted to be operationally connected to an electronic device and at least one attaching member designed to attach the elongated member to the electronic device. The elongated member is designed to be in contact with at least a portion of a person's hand.

### RELATED APPLICATIONS

The present application claims benefit of U.S. Provisional Application No. 61/540,874 filed Sep. 29, 2011, which application is incorporated herein by reference in its entirety.

### BACKGROUND OF THE INVENTION

The present invention generally relates to hand straps and, in particular, to a strap for handheld items, such as electronic devices.

Handheld items, such as electronic devices, can slip out of a user's hand causing the item to be “fumbled” while the user is walking or running or if the user's arm is bumped in a crowd, such as at a sporting event. When fumbled, an item can be sent crashing to the ground, causing loss of data and expensive repairs or replacements if the item is an electronic device.

As can be seen, there is a need for a more secure method of holding electronic devices.

### SUMMARY OF THE INVENTION

In one aspect of the present invention, a strap assembly is provided comprising an elongated member adapted to be operationally connected to an electronic device and designed to be in contact with at least a portion of a person's hand; and at least one attaching member designed to attach the elongated member to the electronic device.

In another aspect of the present invention, a strap assembly is provided comprising an elongated member adapted to be operationally connected to a handheld item and designed to be in contact with at least a portion of a person's hand; attaching members secured to an inner surface at each end of the elongated member and designed to attach the elongated member to the electronic device; and a design area on an outer surface of the elongated member and having approximately the same length as the elongated member.

These and other features, aspects and advantages of the present invention will become better understood with reference to the following drawings, description and claims.

### BRIEF DESCRIPTION OF THE DRAWINGS

FIG. 1 is a perspective view of a strap assembly according to one embodiment of the present invention shown in use;

FIG. 2 is a back view of the strap assembly of FIG. 1;

FIG. 3 is a top view of the strap assembly of FIG. 2; and

FIG. 4 is a cross-sectional view of the strap assembly taken through line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides an elastic strap assembly for handheld items, such as cell phones, tablet computers, MP3 players, and other electronic handheld devices,. A strap assembly of the present invention, which may be referred to as a “Fumblenot” strap device, may be attached to the item, allowing the user to more securely hold the item with one hand.

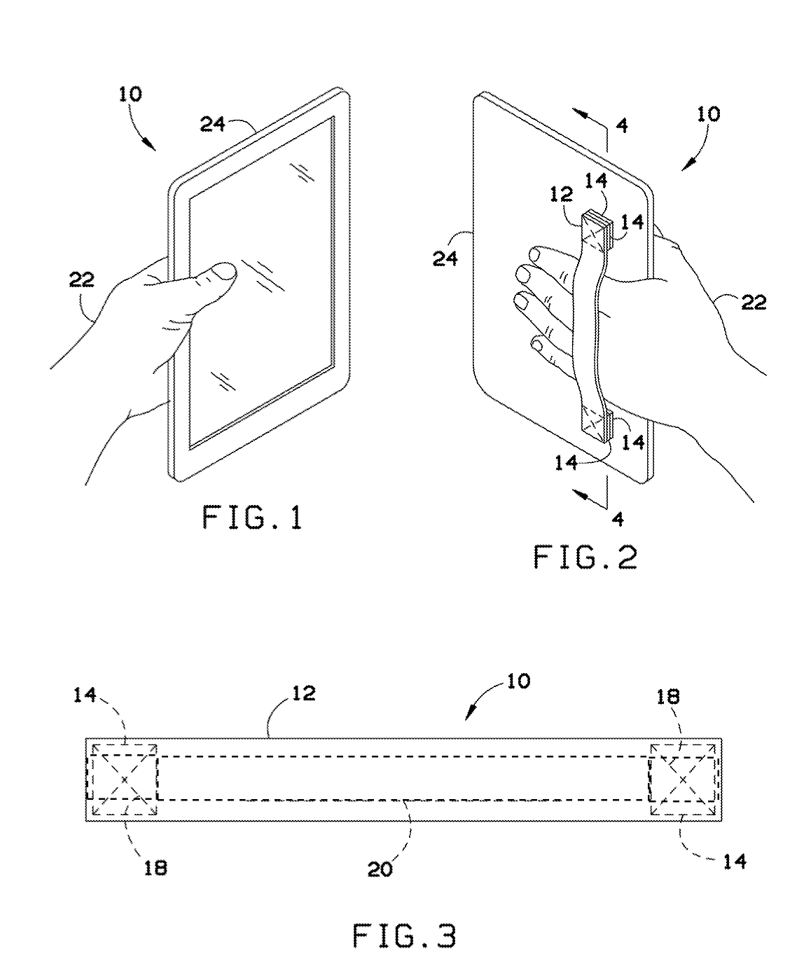

A strap assembly 10 according to an embodiment of the present invention is shown in FIGS. 1-4. The strap assembly 10 may include an elongated member 12 and at least one attaching member 14. For some embodiments, the outer surface of the elongated member 12 may include a design area 20 adapted to receive a printed trademark or logo.

The elongated member 12 may be designed to be in contact with at least a portion of a person's hand 22. The elongated member 12 may be adapted to be operationally connected to a handheld item, illustrated in the Figures as an electronic device 24, such as a tablet computer, a cell phone, an electronic reader, and a laptop computer. For some embodiments, the elongated member 12 may comprise an elastic strap. For some embodiments, the elongated member 12 may have a length between about 2 inches and about 6 inches. For some embodiments, the elongated member 12 may have a width between about ¾ inch and about 1 inch. The dimensions of the elongated member 12 may vary and may depend on the dimensions and the weight of the electronic device 24. The elongated member 12 may be configured to be in contact with the attaching member 14.

The attaching member 14 may be designed to attach the elongated member 12 to the electronic device 24. For some embodiments, the attaching member 14 may be designed to releasably attach the elongated member 12 to the electronic device 24. For some embodiments, the attaching member 14 may be designed to permanently affix the elongated member 12 to the electronic device 24.

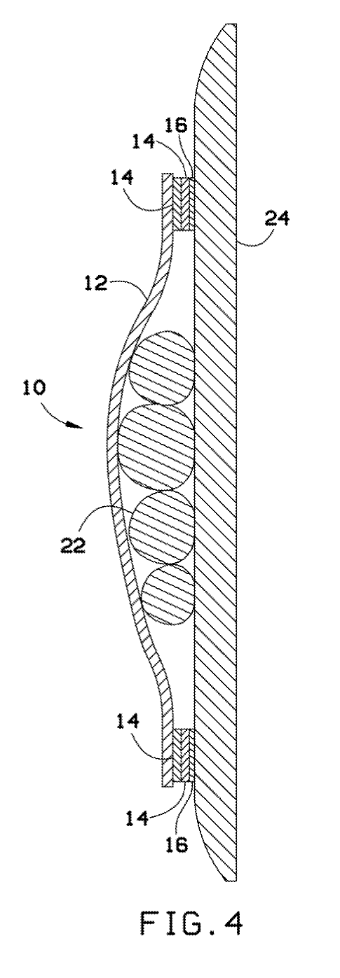

For some embodiments, the attaching member 14 may comprise a two-part hook and loop fastener, such as Velcro®, and may include an adhesive 16, such as a pressure sensitive self-adhesive on the back of one of the two parts of the hook and loop fastener, as shown in FIG. 4. For these embodiments, the adhesive 16 may be designed to stick to the back or to the underside of the electronic device 24. For some embodiments, the attaching member 14 may comprise a truss catch. For these embodiments, the truss catch may be designed to hook into a built in slot on the back or the underside of the electronic device 24.

For some embodiments, the attaching member 14 may be attached to the inner surface of the elongated member 12 by a plurality of stitches 18. For some embodiments, one attaching member 14 may be sewn onto each end of the elongated member 12 or may be secured with adhesive.

For some embodiments, the strap assembly 10 may be applied in a variety of positions allowing for a custom application by the user. For example, two strap assemblies 10 may be applied in an X-shape or one strap assembly 10 may be attached in any user preferred position.

For some embodiments, the strap assembly 10 may be designed to allow the user to slide at least a portion of their hand 22, for example one or two fingers, under the elongated member 12 to increase stability while in motion and using the device 24. For some embodiments, the strap assembly 10 may be designed to be attached to other items that a person may carry.

For some embodiments, the design area 20 may be sewn onto the outer surface of the elongated member 12 or may be affixed to the outer surface of the elongated member 12 with adhesive. In some embodiments, the design area 20 may be approximately the same length as the elongated member 12 and be sewn onto the outer surface the elongated member 12 when the attaching members 14 are sewn onto the ends of the inner surface of the elongated member 12.

It should be understood, of course, that the foregoing relates to exemplary embodiments of the invention and that modifications may be made without departing from the spirit and scope of the invention as set forth in the following claims.

What is claimed is:

1. A strap assembly comprising:
an elongated member adapted to be operationally connected to an electronic device, the elongated member designed to be in contact with at least a portion of a person's hand; and
at least one attaching member designed to attach the elongated member to the electronic device.

2. The strap assembly of claim 1, wherein the elongated member comprises an elastic strap.

3. The strap assembly of claim 1, wherein the elongated member has a length in a range from about 2 inches to about 6 inches and a width in a range from about ¾ inches to about 1 inch.

4. The strap assembly of claim 1, wherein the at least one attaching member comprises a hook and loop fastener having a first part secured to the electronic device and a second part secured to an inner surface of the elongated member.

5. The strap assembly of claim 4, wherein the first part of the hook and loop fastener is secured to the electronic device with adhesive.

6. The strap assembly of claim 4, wherein the second part of the hook and loop fastener is secured to the inner surface with a plurality of stitches.

7. The strap assembly of claim 1, further comprising a design area on an outer surface of the elongated member.

8. The strap assembly of claim 7, wherein the design area is approximately the same length as the elongated member.

9. A strap assembly comprising:
an elongated member adapted to be operationally connected to a handheld item, the elongated member designed to be in contact with at least a portion of a person's hand;
attaching members secured to an inner surface at each end of the elongated member and designed to attach the elongated member to the handheld item; and
a design area on an outer surface of the elongated member and having approximately the same length as the elongated member.

10. The strap assembly of claim 9, wherein:
the attaching members are secured to the inner surface at the ends of the elongated member with a plurality of stitches; and
ends of the design area are secured to the outer surface of the elongated members with the plurality of stitches that secure the attaching members.
